(19) United States
(12) Patent Application Publication
(10) Pub. No.: US 2010/0167654 A1
(43) Pub. Date: Jul. 1, 2010

(54) APPARATUS AND METHOD OF DETERMINING MODIFICATION OF WIRELESS SERVICE USE FOR SPECTRUM LIBERALIZATION

(75) Inventors: Ho Kyung SON, Daejeon (KR); Heon Jin Hong, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/560,789

(22) Filed: Sep. 16, 2009

(30) Foreign Application Priority Data
Dec. 19, 2008 (KR) 10-2008-0130493

(51) Int. Cl. H04B 15/00

(52) U.S. Cl. 455/63.1

(57) ABSTRACT

An apparatus and method of determining a modification of a wireless service use for spectrum liberalization is provided. When a licensee using a wireless service in a particular band desires to modify the wireless service use, the method of determining a modification of a wireless service use for spectrum liberalization may determine whether to modify the wireless service use through a worst-case interference check scheme and a Monte-Carlo interference check scheme.

### CROSS-REFERENCE TO RELATED APPLICATION

This application claims the benefit of Korean Patent Application No. 10-2008-0130493, filed on Dec. 19, 2008, in the Korean Intellectual Property Office, the disclosure of which is incorporated herein by reference.

### BACKGROUND

1. Field

Example embodiments relate to a method of determining a modification of a wireless service use for spectrum liberalization, and more particularly, to a method of determining a modification of a wireless service use for spectrum liberalization that may, when a licensee using a wireless service in a particular band desires to modify a use of the wireless service, determine the modification of the wireless service use through a worst-case interference check and a Monte-Carlo interference check without interfering with a same band or adjacent band.

2. Description of the Related Art

Currently, a use of a particular frequency band having inferior propagation characteristics in wireless communication increases. However, the development of a new service and wireless technology using the band has been restricted due to frequency occupation of existing wireless service systems. Also, it is predicted that an efficiency of a wireless communication is reduced, since a higher frequency band is used. Accordingly, a new paradigm for a frequency use is required.

That is, an increase in frequency use efficiency is critical to overcome a lack of frequency resources. For this, a frequency should be flexibly used without national regulations concerning frequency allocation and usage. A neutral technology and a neutral service are required for the new paradigm of frequency management. Neutral technology may indicate ‘no interference’ regardless of techniques of different wireless systems providing a service in a same or adjacent band. Neutral service may indicate that all services are to be provided in all assigned bands. The neutral technology and neutral service may ultimately represent spectrum liberalization. For spectrum liberalization, a method to determine a modification of a wireless service use in a spectrum band is required.

A Minimum Coupling Loss (MCL) method and a Monte-Carlo method are mainly used for an interference analysis among wireless communication systems.

MCL may calculate a minimum distance, that is, a spaced distance or a spaced frequency (protection band), where a plurality of systems are spaced apart to be operated without a mutual interference, through a system parameter and a propagation model. In MCL, the worst case where a regular signal is continuously received may be assumed and an activity factor of a transceiver may be disregarded. Accordingly, an extremely long distance or spaced frequency (protection band) which is not practically applied may be obtained.

Systems may be suitably operated with a minimum spaced frequency (protection band) or distance which is less than results obtained using MCL. Accordingly, a worst result obtained using MCL is controversial.

A Monte-Carlo method may be used to designate all parameters associated with an interference environment, and statistically compute a probability of interference. Although a Monte-Carlo method may be complex, and a difference in a probability of interference may exist depending on an input parameter value, all interference environments may be simulated.

Currently, an interference analysis method using a Monte-Carlo method has been provided. The interference analysis method may determine a sharing possibility of a frequency, and provide a technical parameter such as a transmission mask for frequency sharing, through an interference analysis with an existing wireless service system that uses an identical or adjacent band of a corresponding frequency.

FIG. 1 is a block diagram illustrating an example when an interference between wireless communication systems occurs.

Referring to FIG. 1, it may be assumed that an interfering antenna system 20 is an antenna system that interferes with an interfered antenna system 10, and the interfered antenna system 10 is an antenna system to be analyzed with respect to interference. In this instance, the interfered antenna system 10 may include an interfered receiver 11 and an opposing transmitter 12. Also, the interfering antenna system 20 may include an interfering transmitter 21 and a target receiver 22.

A Desired Receiving Signal Strength (DRSS) may denote a strength of a signal received by the interfered receiver 11 from the opposing transmitter 12. An Interfering Receiving Signal Strength (IRSS) may denote a strength of a signal received by the interfered receiver 11 from the interfering transmitter 21. In this instance, the signal received by the interfered receiver 11 from the interfering transmitter 21 may cause an interference in the interfered receiver 11.

Also, an interfered link 13 may indicate a link between the interfered receiver 11 and the opposing transmitter 12, and an interfering link 23 may indicate a link between the interfered receiver 11 and the interfering transmitter 21.

Hereinafter, a method of computing a probability of interference in an antenna system using a Monte-Carlo method in a conventional art is described.

A parameter of each of the interfered receiver 11, the opposing transmitter 12, the interfering transmitter 21, and the target receiver 22 may be set. A link parameter between the interfered receiver 11 and the opposing transmitter 12, and a link parameter between the interfering transmitter 21 and the target receiver 22 may be set.

Also, the DRSS and the IRSS may be computed.

In this instance, the DRSS may be represented as,

DRSS=p_{wt supplied}g_{wt→vr}−pl_{wt→vr}(fᵥᵣ)+g_{vr→wt} [Equation 1]

where p_{wt supplied} may denote a power supplied to the opposing transmitter 12. Also, g_{wt→vr} and pl_{wt→vr} may denote an antenna gain from the opposing transmitter 12 to the interfered receiver 11 and a path loss between the opposing transmitter 12 and the interfered receiver 11, respectively.

In general, an interference mechanism may be divided into a blocking, a unwanted emission, an intermodulation, and the like. The IRSS for each interference mechanism may be represented as,

IRSS_{block,j}=(p_{itsupplied}+g_{ilPC}+g_{il→vr}−pl_{it→vr}+aᵥᵣ+g_{vr→it}) [Equation 2]

where IRSS_{block,i} may denote a strength of an interference blocking signal, received from an i^{th} interfering transmitter, and p_{it supplied} may denote a power supplied to the interfering transmitter 21. g_{itpc} may denote a power control gain with respect to the interfering transmitter 21 in a power control function. p_{it→vr} and g_{vr→it} may denote an antenna gain towards the interfering transmitter 21 and the interfering transmitter 21 to the interfered receiver 11, and an antenna gain from the interfered receiver 11 to the interfering transmitter 21, respectively. Also, aᵥᵣ and pl_{it→vr} may denote a blocking attenuation of the interfered receiver 11 and a path loss between the interfered receiver 11 and the interfering transmitter 21, respectively.

IRSS _{unwanted}_{_{—}}ᵢ=(emissionᵢₜ(fᵢₜ,fᵥᵣ)+g_{it→vr}−pl_{it→vr}(fᵥᵣ)+g_{vr→it}) [Equation 3]

where IRSS_{unwanted}_{_{—}}ᵢ may denote a strength of an interference signal received in the interfered receiver 11 from an unwanted emission of the i^{th} interfering transmitter.

Also, emissionᵢₜ(fᵢₜ, fᵥᵣ) may denote a strength of an interference signal received from a bandwidth of the interfered receiver 11, and may be obtained by a function of a transmission power strength of the interfering transmitter 21, an unwanted emission mask, and the like.

I_{i,j}RSS_{intermod}=2*IᵢRSSᵢₙₜ+IⱼRSSᵢₙₜ−3intermod−3sensᵥᵣ−9 dB [Equation 4]

where I_{i,j}RSS_{intermod} may denote a strength of an intermodulation interference signal received from the i^{th} interfering transmitter and an j^{th} interfering transmitter, intermod may denote a 3^{rd} intermodulation attenuation, and sensᵥ may denote a sensitivity of the interfered receiver 11.

Accordingly, a probability of interference (P) may be computed to be equal to or less than a Carrier-to-Interference ratio (C/I) required by the DRSS/IRSS, when the DRSS is received at a value equal to or greater than a receive sensitivity level.

That is, when a particular parameter, which is not a fixed value, from among the input parameters is inputted, each parameter of a corresponding range may be applied, the DRSS and the IRSS may be computed, and a number of times that the DRSS/IRSS is equal to or less than the threshold value (C/I) may be divided into a total number of times to compute the probability of interference, which is represented as,

$$P = P \{ \frac{DRSS}{IRSS} < \frac{C}{I} \vert DRSS > sens \} . \qquad [ Equation 5 ]$$

The above-described method of computing a probability of interference in an antenna system using a Monte-Carlo method in a conventional art may have an advantage that a probability of interference is computed based on an actual environment. However, the above-described method may not be good enough to determine a wireless service use modification for spectrum liberalization.

### SUMMARY

Example embodiments may provide a method and apparatus of determining a modification of a wireless service use for spectrum liberalization which may, when a licensee desires to modify a service use, evaluate an interference that affects another service in a same or adjacent band, compare the interference with an admissible interference threshold value, and thereby may determine whether to modify the service use.

According to example embodiments, there may be provided a method of determining a modification of a wireless service use for spectrum liberalization, the method including: setting an input parameter of each of an interfered receiver, an interfering transmitter, an opposing transmitter, and a target receiver; computing a first interference signal strength, received from the interfering transmitter by the interfered receiver, using the input parameter and a worst-case interference check scheme; comparing the first interference signal strength with an admissible interference threshold value; computing a second interference signal strength, received from the interfering transmitter by the interfered receiver, using a Monte-Carlo interference check scheme, when the first interference signal strength is greater than the admissible interference threshold value; comparing the second interference signal strength with the admissible interference threshold value; and determining the modification of the wireless service use depending on a result of the comparison.

According to example embodiments, there may be provided an apparatus of determining a modification of a wireless service use for spectrum liberalization, the apparatus including: a setting unit to set an input parameter of each of an interfered receiver, an interfering transmitter, an opposing transmitter, and a target receiver; an interference signal strength computation unit to compute a first interference signal strength, received from the interfering transmitter by the interfered receiver, using the input parameter and a worst-case interference check scheme, or to compute a second interference signal strength, received from the interfering transmitter by the interfered receiver, using a Monte-Carlo interference check scheme; a comparison unit to compare the first interference signal strength or the second interference signal strength with an admissible interference threshold value; and a determination unit to determine the modification of the wireless service use depending on a result of the comparison.

According to the present invention, a method and apparatus of determining a modification of a wireless service use for spectrum liberalization may, when a licensee desires to modify a service use, evaluate an interference that affects another service in a same or adjacent band, compare the interference with an admissible interference threshold value, and thereby may determine whether to modify the service use.

Additional aspects of the example embodiments will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the example embodiments, taken in conjunction with the accompanying drawings of which:

FIG. 1 illustrates an example when an interference between wireless communication systems occurs;

FIG. 2 illustrates a flowchart of a method of determining a modification of a wireless service use for spectrum liberalization according to example embodiments;

FIGS. 3A, 3B, and 3C illustrate examples of a parameter associated with a method of determining a modification of a wireless service use for spectrum liberalization according to example embodiments;

FIG. 4 illustrates an example of a parameter used for an interference computation associated with a method of determining a modification of a wireless service use for spectrum liberalization according to example embodiments; and

FIG. 5 illustrates a configuration of an apparatus of determining a modification of a wireless service use for spectrum liberalization according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

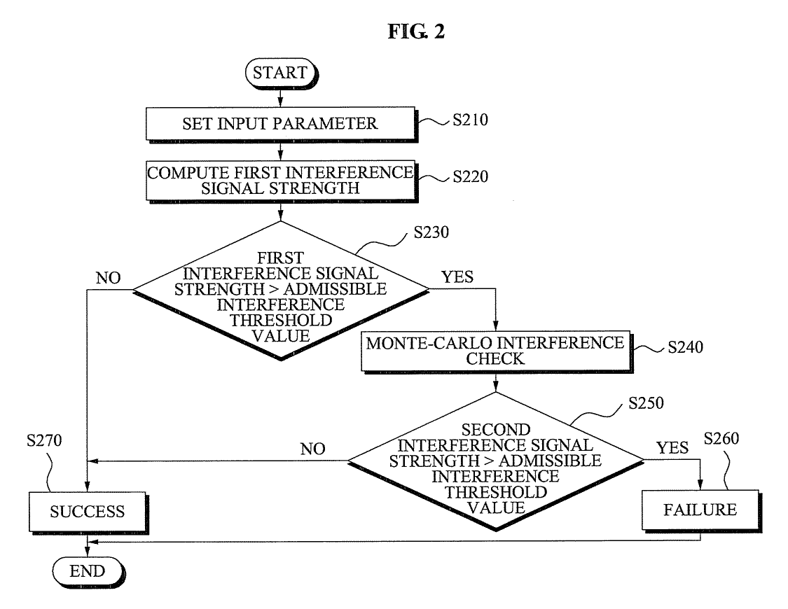

FIG. 2 illustrates a flowchart of a method of determining a modification of a wireless service use for spectrum liberalization according to example embodiments.

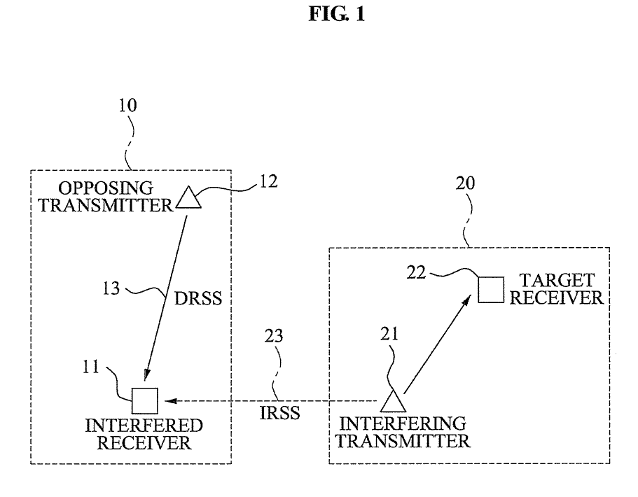

Referring to FIGS. 1 and 2, in operation S210, an apparatus of determining a modification of a wireless service use for spectrum liberalization, hereinafter, referred to as ‘apparatus’, may set an input parameter of each of an interfered receiver 11, an interfering transmitter 21, an opposing transmitter 12, and a target receiver 22. In this instance, the input parameter may include a parameter required for a worst-case interference check and a Monte-Carlo interference check.

In operation S220, the apparatus may compute a first interference signal strength, received from the interfering transmitter 21 by the interfered receiver 11, using the input parameter and a worst-case interference check scheme.

In operation S230, the apparatus may compare the first interference signal strength with an admissible interference threshold value to determine whether the first interference signal strength is greater than the admissible interference threshold value. The first interference signal strength may be computed with respect to a worst case.

Also, in operation S230, the apparatus may compute the admissible interference threshold value according to a size where a bandwidth of an interferer and a bandwidth of a victim are overlapped based on an inputted admissible interference threshold value, when comparing the first interference signal strength and the admissible interference threshold value.

For example, in operation S230, when the overlapped bandwidth of the interferer and the victim is equal to or greater than a bandwidth of a victim receiver, the apparatus may use the inputted admissible interference threshold value. When the overlapped bandwidth of the interferer and the victim is less than the bandwidth of the victim receiver, the apparatus may compute a new admissible interference threshold value based on an admissible interference level correction factor which is associated with the overlapped bandwidth of the interferer and the victim.

In operation S240, when the first interference signal strength is greater than the admissible interference threshold value, the apparatus may compute a second interference signal strength, received from the interfering transmitter 21 by the interfered receiver 11, using the Monte-Carlo interference check scheme.

In operation S250, the apparatus may compare the second interference signal strength with the admissible interference threshold value to determine whether the second interference signal strength is greater than the admissible interference threshold value.

In operation S260, when the second interference signal strength is greater than the admissible interference threshold value, the apparatus may determine the modification of the wireless service use is not performed.

In operation S270, when the second interference signal strength is equal to or less than the admissible interference threshold value, the apparatus may determine the modification of the wireless service use passes.

As described above, when a licensee desires to modify the wireless service use, the method of determining a modification of a wireless service use may evaluate an interference that affects another service in a same or adjacent band, compare the interference with an admissible interference threshold value, and thereby may determine whether to modify the service use.

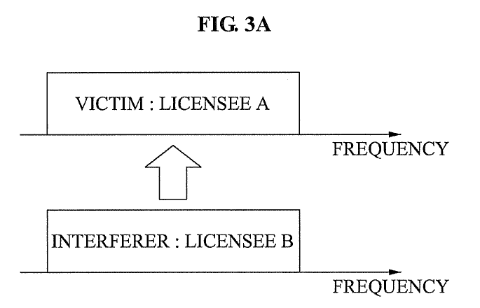

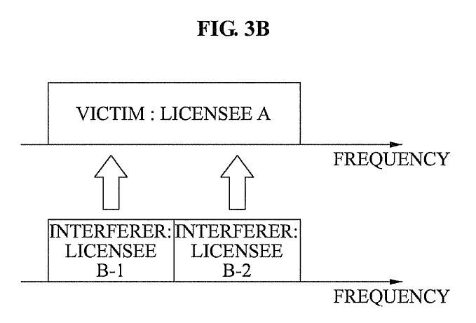

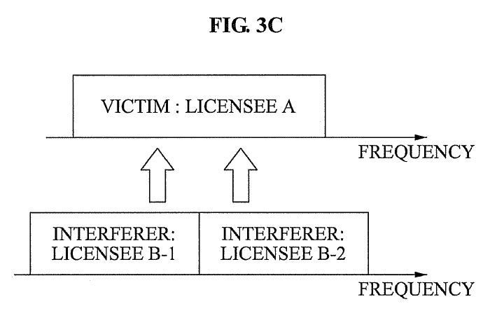

FIGS. 3A, 3B, and 3C illustrate examples of a parameter associated with a method of determining a modification of a wireless service use for spectrum liberalization according to example embodiments.

Referring to FIGS. 2, 3A, 3B and 3C, in operation S230 and operation S250, an admissible interference level of the admissible interference threshold value may be determined by the set input parameter. In this instance, the admissible interference level may be, for example, XdBW, Y % time rate, Z % location rate, and may indicate a size where a band of a licensee A and a band of a licensee B are overlapped. The licensee B corresponding to an interferer desires to modify a wireless service use, and the licensee A corresponding to a victim provides a service in a same or adjacent band.

FIG. 3A illustrates an example when the licensee A (victim) and the licensee B (interferer) use a same band. FIG. 3B illustrates an example when a band of each of licensees B-1 and B-2 (interferer) is identical to a half of a band of the licensee A (victim). FIG. 3C illustrates an example when a half of a sum of bands of the licensees B-1 and B-2 (interferer) is identical to the band of the licensee A (victim).

For example, when the overlapped bandwidth of the interferer and the victim is equal to or greater than a bandwidth of a victim receiver, the apparatus may use an inputted admissible interference threshold value. When the overlapped bandwidth of the interferer and the victim is less than the bandwidth of the victim receiver, the apparatus may compute a new admissible interference threshold value according to Equation 6 as below.

$$Aoverlap = \{ \begin{matrix}0 & {OL}_{VI} \geq {BW}_{V} \\ 10 log ( \frac{{OL}_{VI}}{{BW}_{V}} ) & {OL}_{VI} < {BW}_{V}\end{matrix} \} \qquad [ Equation 6 ]$$

where Aoverlap may denote an admissible interference level correction factor which is associated with the overlapped bandwidth of the interferer and the victim. OL_{Vl} and BW_{L} may denote a size where the bandwidth of the interferer and the bandwidth of the victim are overlapped, and a bandwidth of a victim system, respectively.

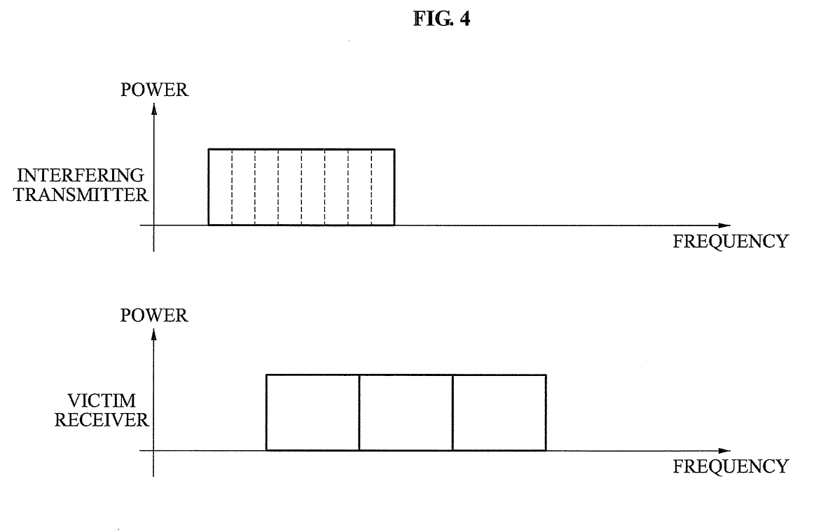

FIG. 4 illustrates an example of a parameter used for an interference computation associated with a method of determining a modification of a wireless service use for spectrum liberalization according to example embodiments.

Referring to FIG. 4, a band used by an interferer may include a plurality of channels. An apparatus may first compute an interference signal strength (I_{ref}) in an intermediate frequency to compute an interference signal for each channel in a victim. Also, the apparatus may compute an interference signal strength in a remaining channel according to Equation 7 and Equation 8 given as below. In this instance, it may be assumed that a transmitter gain, a path loss, a receiver gain, and a receiver loss are regular with respect to each of the channels. Also, a frequency, an Effective

Isotropically Radiated Power (EIRP), an activation factor may vary for each of the channels.

$$I = {I}_{ref} + {I}_{Extra} \\ {I}_{Extra} = 10 log {\sum }_{z} {10}^{( EIRP + {A}_{BW} ) / 10} \qquad [ Equation 7 ]$$

where I_{ref} may denote the intermediate frequency of a channel, that is, the interference signal strength computed by f=(fₘₐₓfₘᵢₙ)/2. A_{BW} may denote the admissible interference level correction factor associated with the bandwidth and the intermediate frequency form, which may be represented as,

$${A}_{BW} = \frac{1}{{BW}_{TX}} {\int }_{- ∞}^{+ ∞} {M}_{tx} ( f ) {M}_{rx} ( f ) d f \qquad [ Equation 8 ]$$

where Mₜₓ(f) may denote a transmitter mask, and Mₜₓ(f) may denote a receiver mask.

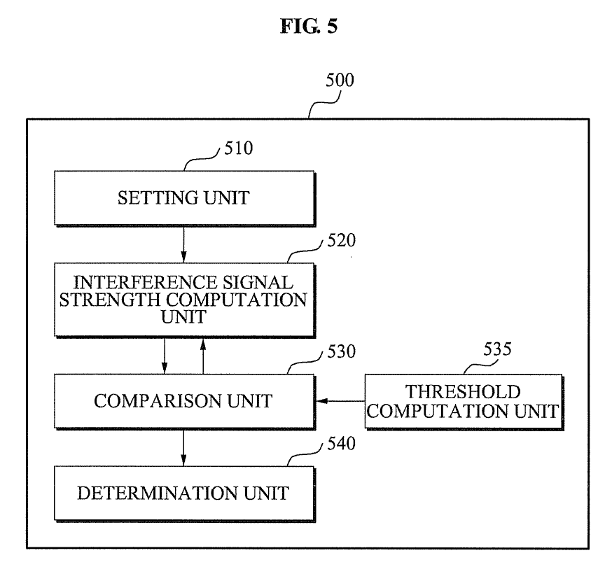

FIG. 5 illustrates a configuration of an apparatus 500 according to example embodiments.

Referring to FIGS. 1 and 5, the apparatus 500 may include a setting unit 510, an interference signal strength computation unit 520, a comparison unit 530, a threshold computation unit 535, and a determination unit 540.

The setting unit 510 may set an input parameter of each of an interfered receiver 11, an interfering transmitter 21, an opposing transmitter 12, and a target receiver 22.

The interference signal strength computation unit 520 may compute a first interference signal strength, received from the interfering transmitter 21 by the interfered receiver 11, using the input parameter and a worst-case interference check scheme.

Also, the interference signal strength computation unit 520 may compute a second interference signal strength, received from the interfering transmitter 21 by the interfered receiver 11, using a Monte-Carlo interference check scheme. That is, when the first interference signal strength is greater than the admissible interference threshold value, the interference signal strength computation unit 520 may compute the second interference signal strength using the Monte-Carlo interference check scheme.

When computing the interference signal in a victim from a band of an interferer, the interference signal strength computation unit 520 may compute an interference signal in an intermediate channel, and compute a strength of the interference signal based on a characteristic value of a transmitter and a receiver based on a frequency, when computing the interference signal in a remaining channel. The band of the interferer may include a plurality of channels.

The interference signal strength computation unit 520 may compute a frequency, an EIRP, an activation factor for each of the channels when computing the interference signal from the plurality of channels, assuming that a transmitter gain, a path loss, a receiver gain, and a receiver loss are regular with respect to each of the channels.

The comparison unit 530 may compare the first interference signal strength or the second interference signal strength with an admissible interference threshold value.

For example, the comparison unit 530 may compare the first interference signal strength with the admissible interference threshold value through the worst-case interference check scheme. Also, when the first interference signal strength is greater than the admissible interference threshold value, the comparison unit 530 may request the interference signal strength computation unit 520 for the computation of the second interference signal strength through the Monte-Carlo interference check scheme.

For another example, the comparison unit 530 may compare the second interference signal strength with the admissible interference threshold value through the Monte-Carlo interference check scheme.

The threshold computation unit 535 may compute the admissible interference threshold value based on a size where a bandwidth of the interferer and a bandwidth of the victim are overlapped based on an inputted admissible interference threshold value.

For example, when the overlapped bandwidth of the interferer and the victim is equal to or greater than a bandwidth of a victim receiver, the threshold computation unit 535 may use the inputted admissible interference threshold value. When the overlapped bandwidth of the interferer and the victim is less than a bandwidth of the victim receiver, the threshold computation unit 535 may compute a new admissible interference threshold value based on an admissible interference level correction factor which is associated with the overlapped bandwidth of the interferer and the victim.

The comparison unit 530 may compare the first interference signal strength or the second interference signal strength with the admissible interference threshold value computed by the threshold computation unit 535.

The determination unit 540 may determine the modification of the wireless service use depending on a result of the comparison. When the first interference signal strength with respect to a worst case is equal to or less than the admissible interference threshold value as the result of the comparison, the determination unit 540 may determine that the modification of the wireless service use is successful. When the second interference signal strength is equal to or less than the admissible interference threshold value as the result of the comparison, the determination unit 540 may determine that the modification of the wireless service use is successful. Also, when the second interference signal strength is greater than the admissible interference threshold value as the result of the comparison, the determination unit 540 may determine that the modification of the wireless service use fails.

As described above, when a licensee desires to modify the wireless service use, the apparatus 500 may evaluate an interference that affects another service in a same or adjacent band, compare the interference with an admissible interference threshold value, and thereby may determine whether to modify the service use.

Although a few example embodiments have been shown and described, it would be appreciated by those skilled in the art that changes may be made in these example embodiments without departing from the principles and spirit of the disclosure, the scope of which is defined in the claims and their equivalents.

What is claimed is:

1. A method of determining a modification of a wireless service use for spectrum liberalization, the method comprising:
setting an input parameter of each of an interfered receiver, an interfering transmitter, an opposing transmitter, and a target receiver;
computing a first interference signal strength, received from the interfering transmitter by the interfered receiver, using the input parameter and a worst-case interference check scheme;
comparing the first interference signal strength with an admissible interference threshold value;
computing a second interference signal strength, received from the interfering transmitter by the interfered receiver, using a Monte-Carlo interference check scheme, when the first interference signal strength is greater than the admissible interference threshold value;
comparing the second interference signal strength with the admissible interference threshold value; and
determining the modification of the wireless service use depending on a result of the comparison.

2. The method of claim 1, wherein the determining determines that the modification of the wireless service use passes, when the first interference signal strength is equal to or less than the admissible interference threshold value as a result of the comparing the first interference signal strength with the admissible interference threshold value.

3. The method of claim 1, wherein the determining determines that the modification of the wireless service use is successful, when the second interference signal strength is equal to or less than the admissible interference threshold value as the result of the comparing the second interference signal strength with the admissible interference threshold value.

4. The method of claim 1, wherein the comparing of the first interference signal strength with the admissible interference threshold value further comprises:
computing the admissible interference threshold value based on a size where a bandwidth of an interferer and a bandwidth of a victim are overlapped based on an inputted admissible interference threshold value.

5. The method of claim 4, wherein, when the overlapped bandwidth of the interferer and the victim is equal to or greater than a bandwidth of a victim receiver, the computing of the admissible interference threshold value uses the inputted admissible interference threshold value, and when the overlapped bandwidth of the interferer and the victim is less than the bandwidth of the victim receiver, the computing of the admissible interference threshold value computes a new admissible interference threshold value based on an admissible interference level correction factor which is associated with the overlapped bandwidth of the interferer and the victim.

6. The method of claim 1, wherein the computing of the first and/or second interference signal strength computes an interference signal in an intermediate channel when computing the interference signal in a victim from a band of an interferer, and computes a strength of the interference signal based on a characteristic value of a transmitter and a receiver based on a frequency, when computing the interference signal in a remaining channel, the band of the interferer including a plurality of channels.

7. The method of claim 6, wherein the computing of the first and/or second interference signal strength computes a frequency, an Effective Isotropically Radiated Power (EIRP), an activation factor for each channel, when a transmitter gain, a path loss, a receiver gain, and a receiver loss are regular with respect to each of the plurality of channels and when the interference signal is computed from the plurality of channels.

8. An apparatus of determining a modification of a wireless service use for spectrum liberalization, the apparatus comprising:
a setting unit to set an input parameter of each of an interfered receiver, an interfering transmitter, an opposing transmitter, and a target receiver;
an interference signal strength computation unit to compute a first interference signal strength, received from the interfering transmitter by the interfered receiver, using the input parameter and a worst-case interference check scheme, or to compute a second interference signal strength, received from the interfering transmitter by the interfered receiver, using a Monte-Carlo interference check scheme;
a comparison unit to compare the first interference signal strength or the second interference signal strength with an admissible interference threshold value; and
a determination unit to determine the modification of the wireless service use depending on a result of the comparison.

9. The apparatus of claim 8, wherein the determination unit determines that the modification of the wireless service use is successful, when the first interference signal strength is equal to or less than the admissible interference threshold value as the result of the comparison.

10. The apparatus of claim 8, wherein the determination unit determines that the modification of the wireless service use is successful, when the second interference signal strength is equal to or less than the admissible interference threshold value as the result of the comparison.

11. The apparatus of claim 8, further comprising:
a threshold computation unit to compute the admissible interference threshold value based on a size where a bandwidth of an interferer and a bandwidth of a victim are overlapped based on an inputted admissible interference threshold value.

12. The apparatus of claim 11, wherein the threshold computation unit uses the inputted admissible interference threshold value, when the overlapped bandwidth of the interferer and the victim is equal to or greater than a bandwidth of a victim receiver, and computes a new admissible interference threshold value based on an admissible interference level correction factor which is associated with the overlapped bandwidth of the interferer and the victim, when the overlapped bandwidth of the interferer and the victim is less than the bandwidth of the victim receiver.

13. The apparatus of claim 8, wherein, when the first interference signal strength is greater than the admissible interference threshold value, the interference signal strength computation unit computes the second interference signal strength using a signal strength, received from the interfering transmitter by the interfered receiver, using the Monte-Carlo interference check scheme.

14. The apparatus of claim 8, wherein the interference signal strength computation unit computes an interference signal in an intermediate channel, when computing the interference signal in a victim from a band of an interferer, and computes a strength of the interference signal based on a characteristic value of a transmitter and a receiver based on a frequency, when computing the interference signal in a remaining channel, the band of the interferer including a plurality of channels.

15. The apparatus of claim 13, wherein the interference signal strength computation unit computes a frequency, an EIRP, an activation factor for each channel when a transmitter gain, a path loss, a receiver gain, and a receiver loss are regular with respect to each of the plurality of channels, and when the interference signal is computed from the plurality of channels.
